(19) United States
(12) Patent Application Publication
(10) Pub. No.: US 2026/0019840 A1
(43) Pub. Date: Jan. 15, 2026

(54) Associating a designated user with a medicament delivery device

(71) Applicant: SHL Medical AG, Zug (CH)

(72) Inventors: Ola Hallström, Nacka Strand (SE); Daniel Carlsson, Nacka Strand (SE); Rasmus Renstad, Nacka Strand (SE)

(21) Appl. No.: 18/992,031

(22) PCT Filed: Jun. 28, 2023
(86) PCT No.: PCT/EP2023/067590

§ 371 Date: Jan. 7, 2025

(30) Foreign Application Priority Data
Jul. 12, 2022 (EP) 22184336.0

(51) Int. Cl. H04W 24/08

(52) U.S. Cl. CPC H04W 24/08

(57) ABSTRACT

A method of a receiver of associating a designated user with a medicament delivery device configured to communicate a medicament delivery event wirelessly to the receiver is provided. The method comprises receiving a wireless signal identifying a medicament delivery device communicating a medicament delivery event, determining whether or not timing of receiving the signal complies with an expected medicament delivery schedule of the designated user, and if so determining that the identified medicament delivery device was used by the designated user for causing the medicament delivery event.

### CROSS-REFERENCE TO RELATED APPLICATIONS

The present application is a U.S. National Phase Application pursuant to 35 U.S.C. § 371 of International Application No. PCT/EP2023/067590 filed Jun. 28, 2023, which claims priority to EP patent application Ser. No. 22/184,336.0 filed Jul. 12, 2022. The entire disclosure contents of these applications are herewith incorporated by reference into the present application.

### TECHNICAL FIELD

The present disclosure relates to methods of a receiver of associating a designated user with a medicament delivery device configured to communicate a medicament delivery event wirelessly to the receiver, and receivers performing the methods.

### BACKGROUND

Medicament delivery devices such as for instance injectors are commonly used for delivering medicament to users suffering for instance from diabetes.

The medicament delivery device may be arranged with a tag for wireless communication of adherence data related to an injection therapy provided by the medicament delivery device, such as for example information specifying time stamp of the medicament delivery event and subsequent disposal indicating the medicament dose having been delivered. identification of dose delivery or cap removal, or other event associated with the device, batch number, type of drug or device, expiry date of medicament, etc. The tag configured to wirelessly communicate the adherence data may be a so-called radio-frequency identification (RFID), a near-field communication (NFC) tag, or even Bluetooth.

When reading the adherence data of the used medicament delivery device with an appropriate wireless receiver in for instance a home of a designated user being associated with the receiver, there may be numerous other injectors capable of wireless communication in the vicinity of the wireless receiver, used for instance by members of the same household or even neighbours.

Thus, even if the wireless receiver receives a unique medicament delivery device identifier along with the adherence data, the receiver cannot ensure that the identified medicament delivery device and the adherence data belongs to the designated user associated with the receiver, and an erroneous registration of a medical event of e.g. a family member or a neighbour may be performed by the receiver.

### SUMMARY

One objective is to solve, or at least mitigate, this problem in the art and to provide a method of a receiver of associating a designated user with a medicament delivery device configured to communicate a medicament delivery event wirelessly to the receiver.

This objective is attained in a first aspect by a method of a receiver of associating a designated user with a medicament delivery device configured to communicate a medicament delivery event wirelessly to the receiver. The method comprises receiving a wireless signal identifying a medicament delivery device communicating a medicament delivery event, determining whether or not timing of receiving the signal complies with an expected medicament delivery schedule of the designated user, and if so determining that the identified medicament delivery device was used by the designated user for causing the medicament delivery event.

This objective is attained in a second aspect by a receiver configured to associate a designated user with a medicament delivery device configured to communicate a medicament delivery event wirelessly to the receiver. The receiver comprises a processing unit and a memory, said memory containing instructions executable by said processing unit, whereby the receiver is operative to receive a wireless signal identifying a medicament delivery device communicating a medicament delivery event, determine whether or not timing of receiving the signal complies with an expected medicament delivery schedule of the designated user; and if so to determine that the identified medicament delivery device.

Assuming for instance that the timing indicates the event occurs on a Monday, the receiver advantageously concludes that the timing complies with the expected medicament delivery schedule of a designated user and thus that the designated use indeed is the user that triggered the medicament delivery event using the medicament delivery device (and that any adherence data just received from the medicament delivery device hence belongs to the designated user).

In an embodiment, the determining that the identified medicament delivery device was used by the designated user for causing the medicament delivery event further comprises registering the communicated medicament delivery event with the designated user.

In an embodiment, it is further determined whether or not strength of the received wireless signal complies with an expected signal strength, and if so it is determined that the identified medicament delivery device was used by said user for causing the medicament delivery event.

In an embodiment, the strength of the received wireless signal is determined to comply with an expected signal strength if the signal strength exceeds a predetermined signal strength threshold value.

In an embodiment, information is further acquired indicating the signal strength of the identified medicament delivery device as measured by at least one neighbouring receiver and it is thereafter determined whether or not the signal strength of the identified medicament delivery device is greater at the receiver than the at least one neighbouring receiver. If so, it is determined that the identified medicament delivery device was used by said user for causing the medicament delivery event.

In an embodiment, the acquiring of information indicating the signal strength comprises acquiring information indicating the signal strength of the identified medicament delivery device as measured by at least two neighbouring receivers, and the determining whether or not the signal strength of the identified medicament delivery device is greater at the receiver than the at least one neighbouring receiver comprises triangulating a position of the identified medicament delivery device based on the signal strengths, wherein if the identified medicament delivery device is closer to the receiver than the at least two neighbouring receivers, it is determined that the identified medicament delivery device was used by said user for causing the medicament delivery event.

The objective is attained in a third aspect by a method of a receiver of associating a designated user with a medicament delivery device configured to communicate a medicament delivery event wirelessly to the receiver. The method comprises receiving at least two wireless signals each identifying a medicament delivery device, at least one of the signals communicating an occurring medicament delivery event, determining whether or not a plurality of the received at least two signals identifies the same medicament delivery device, and if so determining that the identified medicament delivery device identified by a plurality of signals was used by the designated user for causing the medicament delivery event.

The objective is attained in a fourth aspect by a receiver configured to associate a designated user with a medicament delivery device configured to communicate a medicament delivery event wirelessly to the receiver. The receiver comprises a processing unit and a memory, said memory containing instructions executable by said processing unit, whereby the receiver is operative to receive at least two wireless signals each identifying a medicament delivery device, at least one of the signals communicating an occurring medicament delivery event, determine whether or not a plurality of the received at least two signals identifies the same medicament delivery device, and if so to determine that the identified medicament delivery device (10) identified by a plurality of signals was used by the designated user for causing the medicament delivery event.

If for instance a packaging in which a batch of medicament delivery device is delivered to a user is equipped with a wireless transmitter, the packaging can be utilized for determining whether or not a designated user has triggered a medicament delivery event by having the transmitter of the packaging transmit the identifier of the medicament delivery device used by the designated user.

Hence, the receiver receives two signals identifying the medicament delivery device, one from the medicament delivery device itself and one from the packaging (or even an appropriate tag carried by the user).

As is understood, the medicament delivery device will communicate that a medicament delivery event has occurred, while the transmitter of the packaging only will send the identifier.

If the receiver determines that two signals have been received which identify the same medicament delivery device, the receiver advantageously concludes that the medicament delivery device is the medicament delivery device for which there also is a corresponding packaging nearby and thus that the designated user indeed is the user that triggered the medicament delivery event using the medicament delivery device.

In a fifth aspect, a computer program comprising computer-executable instructions is provided for causing a receiver of the second and fourth aspect to perform steps recited in the method according to the first aspect and third aspect, respectively, when the computer-executable instructions are executed on a processing unit included in the receiver.

In a sixth aspect, a computer program product is provided comprising a computer readable medium, the computer readable medium having the computer program according to the sixth aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 illustrates a prior art scenario;

FIG. 2 illustrates a receiver of an embodiment;

FIG. 3 shows a flowchart illustrating a method of a receiver of associating a designated user with a medicament delivery device configured to communicate a medicament delivery event wirelessly to the receiver according to an embodiment;

FIG. 4 shows a flowchart illustrating a method of a further embodiment;

FIG. 5 illustrates a receiver of a further embodiment;

FIG. 6 shows a flowchart illustrating a method of yet a further embodiment;

FIG. 7 illustrates a receiver of still a further embodiment;

FIG. 8 illustrates a receiver of a further aspect;

FIG. 9 shows a flowchart illustrating a method of the aspect set forth in FIG. 8; and

FIG. 10 illustrates a receiver of a further embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

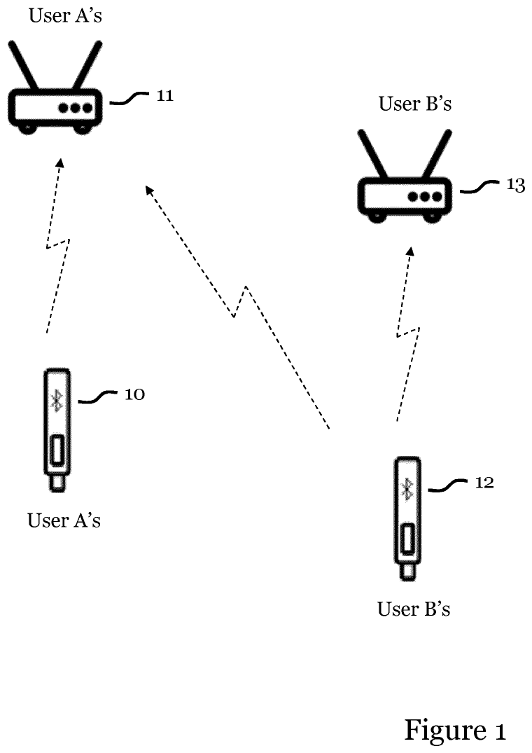

FIG. 1 illustrates a prior art scenario where upon a user utilizing a first medicament device 10, in the following exemplified in the form of an injector, for delivering medicament, the first injector 10 wirelessly transmits a signal to a first wireless receiver 11 that a medicament delivery even has occurred along with appropriate data (commonly referred to as adherence data) and an identifier for the first injector 10

Upon receiving the signal, the first receiver 11 concludes from the identifier that the signal originates from the first device 10 and will further assume that the medicament delivery event was triggered by a designated user associated with the first receiver 11, in the following referred to as user A.

As mentioned, the wireless communication may be established using any appropriate wireless channel, such as e.g. RFID, NFC, Bluetooth, long range (LoRa) technology or ultra-wideband (UWB) radio.

However, assuming that a second injector 12 communicating with a second wireless receiver 13 is in a vicinity of the first receiver 11. The second injector 12 and second receiver 13 may be used by a household member or a neighbour depending on wireless signal range, referred to as user B being associated with the second receiver 13.

Hence, it may occur that the first receiver 11 is within the range of the second injector 12, and the first receiver 11 receiving the identifier and adherence data of the second injector 12 erroneously assumes that the medicament delivery event was triggered by user A.

As a consequence, in addition to incorrectly registering the medicament delivery event of the second injector 12 as being triggered by user A, the first receiver will further receive incorrect adherence data which really belongs to user B. As is understood, the second receiver 13 may erroneously register a medicament delivery even of user A by receiving signals from the first injector 10.

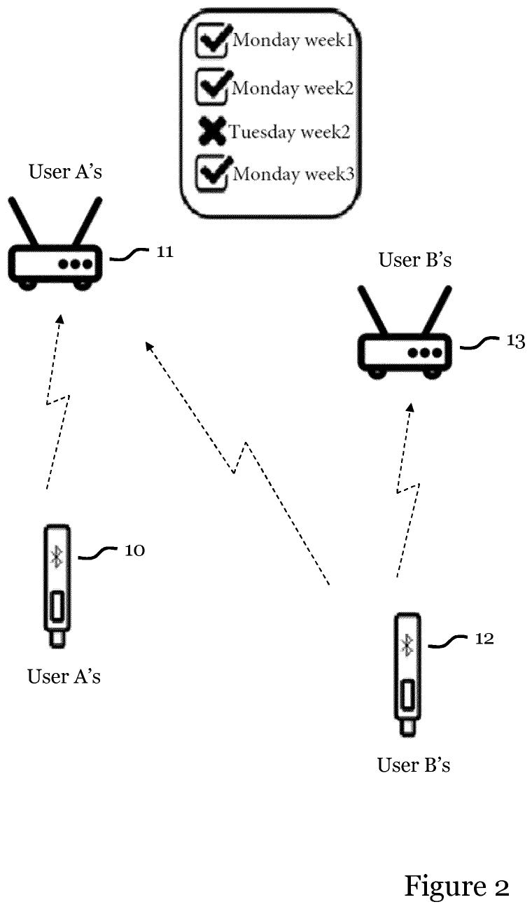

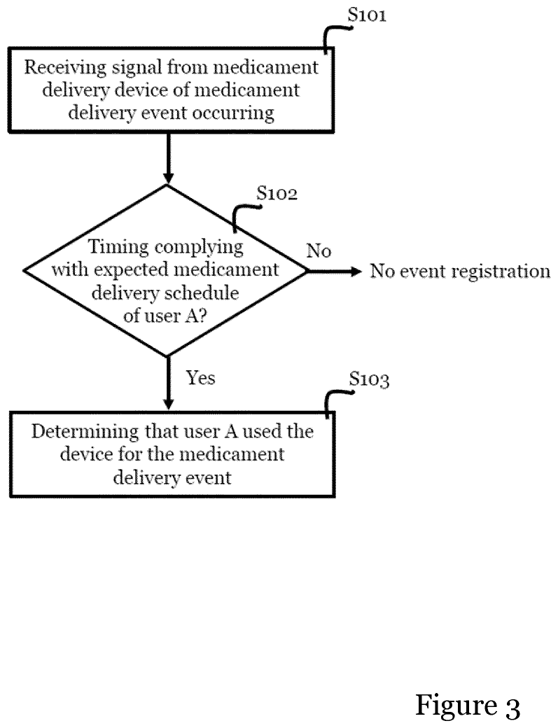

To resolve this issue, reference is made to FIG. 2 illustrating an embodiment. Reference is further made to FIG. 3 showing a flowchart illustrating a method of a receiver (i.e. first receiver 11) of associating a designated user (i.e. user A) with a medicament delivery device (i.e. first injector 10) configured to communicate a medicament delivery event wirelessly to the receiver.

Hence, in a first step S101, the first wireless receiver 11 receives a signal identifying the first injector 10 and thus that a medicament delivery event has occurred.

Thereafter, the first receiver 11 determines whether or not timing of receiving the signal complies with an expected medicament delivery schedule of the designated user, i.e. user A being associated with the first receiver 11.

In an example, the signal transmitted from the first injector 10 is configured with a timestamp of the medicament delivery event, or the first receiver 11 timestamps the signal upon reception.

As illustrated in FIG. 2, user A is expected to trigger the medicament delivery event on Mondays. As is understood, a narrower window may be envisaged, such as Mondays between 12:00 and 14:00, Tuesdays between 10:00 and 12:00 and between 20:00 and 22:00 in case of bidaily delivery, all days between 13:00 and 15:00, etc.

The expected medicament delivery schedule of user A may be stored at the first receiver 11 or in a back-end structure such as a cloud storage.

Assuming for instance that the timing indicates the event occurs on a Monday, the first receiver 11 advantageously concludes in step S103 that the timing complies with the expected medicament delivery schedule of user A and thus that user A indeed is the user that triggered the medicament delivery event using the first injector 10 (and that any adherence data just received from the first injector 10 hence belongs to the user A).

In practice, the first receiver 11 will in step 103 register the communicated medicament delivery event with user A.

In contrast, should the first receiver 11 wirelessly receive a signal from the second injector 12 (including an identifier of the second injector 12 appropriately communicating a medicament delivery event having occurred) being utilized by user B, it likely that user B will have a different medicament delivery schedule as compared to user A.

In this exemplifying embodiment, assuming that the first receiver 11 concludes in step S102 that the timing of reception of the signal from user B indicates a Tuesday, then the first receiver 11 will assume in step S103 that the signal was not received from the designated user associated with the first receiver 11—i.e. user A—and no medicament delivery event will be registered.

In a further embodiment, assuming that the expected medicament delivery schedule of user A is similar to that of user B, it may not be possible for the first receiver 11 to distinguish which of the first injector 10 and the second injector 12 actually was triggered by user A.

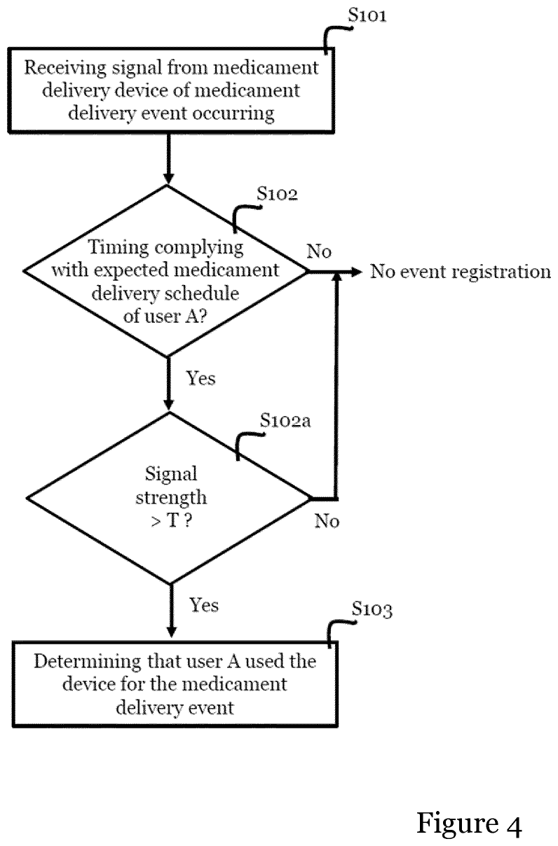

FIG. 4 shows a flowchart illustrating a method of a further embodiment. Thus, assuming that the first receiver 11 concludes in step S102 that a signal received in step S101 indicates to be received at a timing complying with the expected medicament delivery schedule of user A (could either originate from the first injector 10 or the second injector 12).

The first receiver 11 then proceeds to step S102a, where the first receiver 11 determines whether or not strength of the received signal complies with an expected signal strength, for instance exceeds a predetermined signal strength threshold value T.

If so, the signal received is likely to originates from an injector being close to the first receiver 11, which in this example would hold true for the first injector 10 but not for the second injector 12.

Advantageously, even if user B would be assigned an expected medicament delivery schedule being similar to—or even overlapping with—that of user A as concluded in step S102, the first receiver 11 would nevertheless determine in step S102a that the signal strength of the signal received from the second injector 12 is not sufficient and will correctly not perform an event registration for the signal received from the second injector 12 triggered by user B.

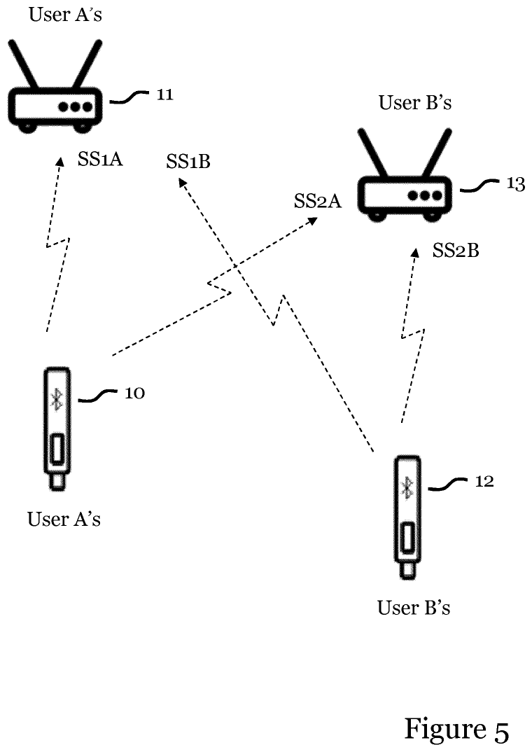

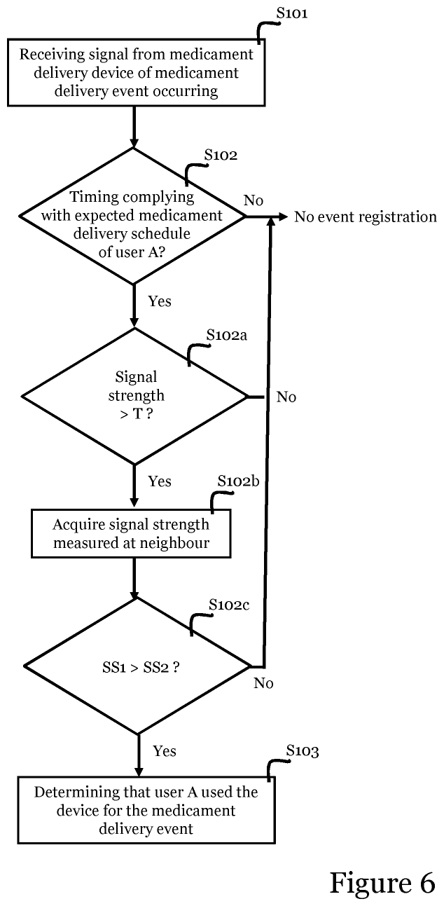

In still another embodiment, with reference to FIGS. 5 and 6, assuming that the second injector 12 triggered by user B is close enough for the strength of the signal transmitted by the second injector 12 to exceed the threshold value T at the first receiver 11, for instance if user A and user B belong to the same household and have similar medicament delivery schedules, a further two steps will be performed.

In step S102b, the first receiver 11 communicates with the second receiver 13, either directly or via a network communication capability, in order to acquire the signal strength of the injector—be it the first injector 10 or the second injector 12—for which the signal currently is received, as measured at the second receiver 13.

Now, if the injector currently transmitting the signal is the first injector 10 (typically being closer to the first receiver 11 than the second receiver 13), the first receiver 11 will likely measure a greater signal strength SSIA for the signal received from the first injector 10 than what would be the case for the signal strength SS2A of the corresponding signal of the first injector 10 measured at the second receiver 13 as determined in step S102c, i.e. SSIA>SS2A.

In such case, it is likely user A that triggered the medicament delivery event at the first injector 10 and a determination to that effect will advantageously be performed in S103.

In contrast, if the injector currently transmitting the signal is the second injector 12 (typically being closer to the second receiver 13 than the first receiver 11), the first receiver 11 will likely measure a weaker signal strength SS1B for the signal received from the second injector 12 than what would be the case for the signal strength SS2B of the corresponding signal measured at the second receiver 13 as determined in step S102c, i.e. SS2B>SS1B.

If so, it is likely user B that triggered the medicament delivery event at the second injector 12 and no event registration will be performed for user A at the first receiver 11.

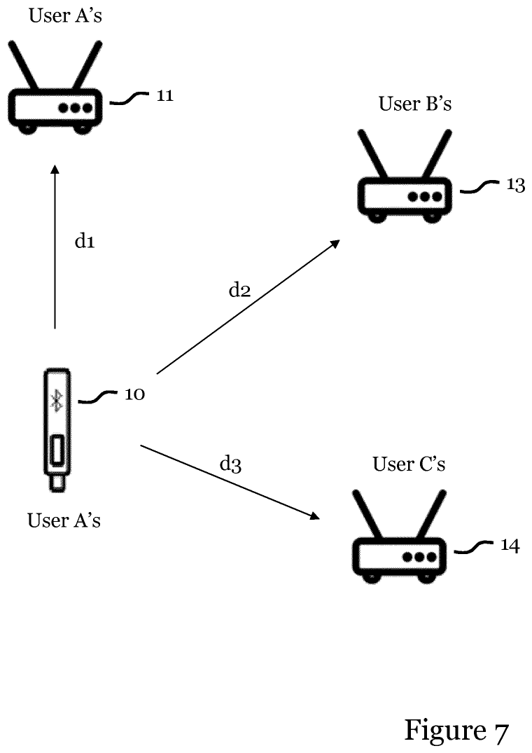

FIG. 7 illustrates a further embodiment where the measurements of FIGS. 5 and 6 are expanded to include yet a neighbouring receiver 14, exemplified in FIG. 7 to belong to a user C.

Similar to the previous embodiment, by having e.g. the first receiver 11 acquire signal strength of the first injector 10 measured at each of the neighbouring receives 13 and 14, it is possible to determine which one of the receivers measures the greatest signal strength of the signal transmitted by the first injector 10 and thus conclude to which of the receivers 11, 13, 14 the first injector is likely to be closest.

However, with three receivers, it is further possible to triangulate a position of the first injector 10 based on the signal strength measured at each respective receiver 11, 13, 14.

In other words, the first receiver 11 may-based on the measured signal strength-determine the respective distance d1, d2, d3 to each receiver 11, 13 and 14, respectively and similar to the previous embodiment, if the injector currently transmitting the signal is the first injector 10 (typically being closer to the first receiver 11 than the second receiver 13 and third receiver 14), the first receiver 11 will likely measure a greater signal strength for the signal received from the first injector 10, and thus a shorter distance d1 than what would be the case for the corresponding distances d2 and d3.

In such case, since the first injector 10 is closest to the first receiver 11, it is likely user A that triggered the medicament delivery event at the first injector 10 and a determination to that effect will advantageously be performed.

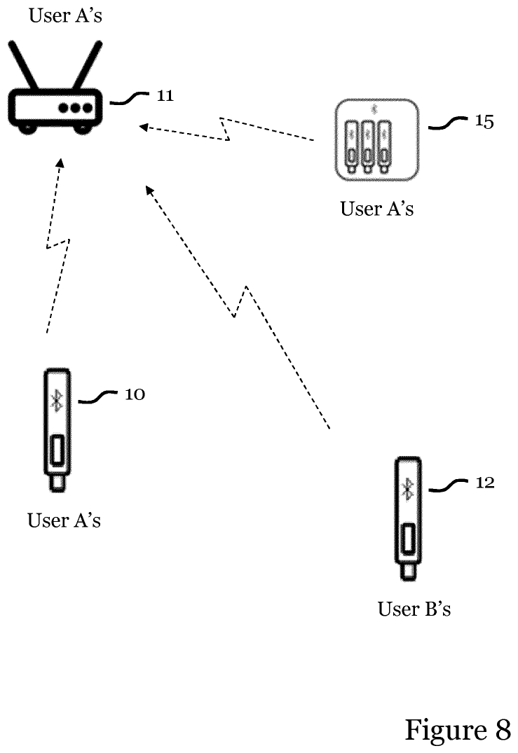

With reference to FIG. 8, in a further aspect, if a packaging 15 in which a batch of injectors is delivered to a user is equipped with a wireless transmitter capable of e,g, RFID, NFC or Bluetooth, the packaging 15 can be utilized for determining whether or not a designated user has triggered a medicament delivery event by having the transmitter of the packaging 15 transmit the identifier of the medicament delivery device used by user A, i.e. the identifier of the first injector 10.

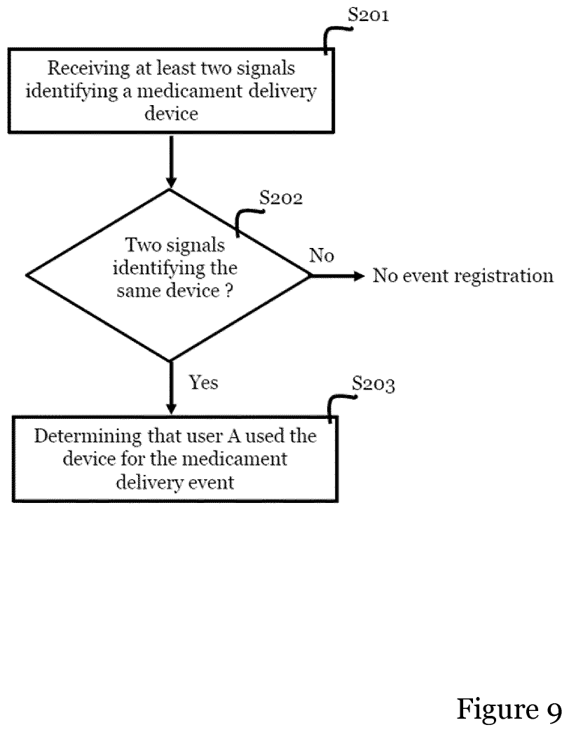

Reference is further made to FIG. 9 showing a flowchart illustrating a method of first receiver 11 of associating user A with first injector 10 communicating a medicament delivery event wirelessly to the first receiver 11.

Hence, in a first step S201, the first wireless receiver 11 receives two signals identifying the first injector 10, one from the first injector 10 itself and one from the packaging 15.

As is understood, the first injector 10 will communicate that a medicament delivery event has occurred, while the transmitter of the packaging 15 only will send the identifier.

In this particular example, the first receiver 11 also receives a signal from the second injector 12 identifying the second injector 12 and communicating a medicament delivery event.

Thereafter, the first receiver 11 determines in step S202 whether or not two signals have been received which identify the same injector, and in this example two signals identify the first injector 10 while only one signal identifies the second injector 12.

If so, the first receiver 11 advantageously concludes in step S203 that first injector 10 is the injector for which there also is a corresponding packaging 15 nearby and thus that user A indeed is the user that triggered the medicament delivery event using the first injector 10 (and that any adherence data just received from the first injector 10 hence belongs to the user A).

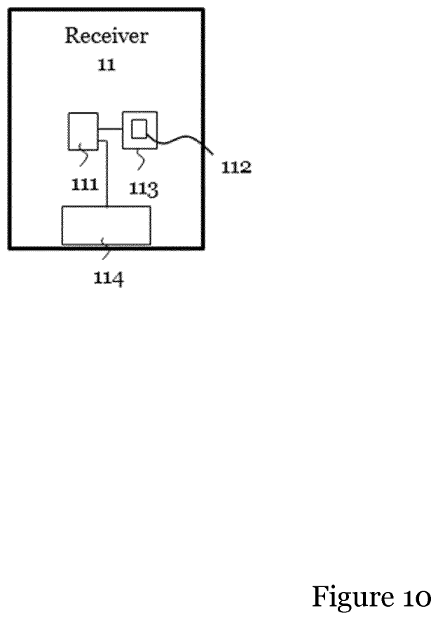

FIG. 10 illustrates a receiver 11 configured to associate a designated user with a medicament delivery device configured to communicate a medicament delivery event wirelessly to the receiver 11 according to an embodiment, where the steps of the method performed by the receiver 11 in practice are performed by a processing unit 111 embodied in the form of one or more microprocessors arranged to execute a computer program 112 downloaded to a storage medium 113 associated with the microprocessor, such as a Random Access Memory (RAM), a Flash memory or a hard disk drive. The processing unit 111 is arranged to cause the receiver 11 to carry out the method according to embodiments when the appropriate computer program 112 comprising computer-executable instructions is downloaded to the storage medium 113 and executed by the processing unit 111. The storage medium 113 may also be a computer program product comprising the computer program 112. Alternatively, the computer program 112 may be transferred to the storage medium 113 by means of a suitable computer program product, such as a Digital Versatile Disc (DVD) or a memory stick. As a further alternative, the computer program 112 may be downloaded to the storage medium 113 over a network. The processing unit 111 may alternatively be embodied in the form of a digital signal processor (DSP), an application specific integrated circuit (ASIC), a field-programmable gate array (FPGA), a complex programmable logic device (CPLD), etc. The receiver 11 further comprises a communication interface 114 (wired and/or wireless) over which the receiver 11 is configured to transmit and receive data using e.g. RFID, NFC, Bluetooth, LoRa technology or UWB radio as previously mentioned.

The medicament delivery devices described herein can be used for the treatment and/or prophylaxis of one or more of many different types of disorders. Exemplary disorders include, but are not limited to: rheumatoid arthritis, inflammatory bowel diseases (e.g. Crohn's disease and ulcerative colitis), hypercholesterolaemia, diabetes (e.g. type 2 diabetes), psoriasis, migraines, multiple sclerosis, anaemia, lupus, atopic dermatitis, asthma, nasal polyps, acute hypoglycaemia, obesity, anaphylaxis and allergies. Exemplary drugs that could be included in the medicament delivery devices described herein include, but are not limited to (with non-limiting examples of relevant disorders in brackets): etanercept (rheumatoid arthritis, inflammatory bowel diseases (e.g. Crohn's disease and ulcerative colitis)), evolocumab (hypercholesterolaemia), exenatide (type 2 diabetes), secukinumab (psoriasis), erenumab (migraines), alirocumab (rheumatoid arthritis), methotrexate (amethopterin) (rheumatoid arthritis), tocilizumab (rheumatoid arthritis), interferon beta-la (multiple sclerosis), sumatriptan (migraines), adalimumab (rheumatoid arthritis), darbepoetin alfa (anaemia), belimumab (lupus), peginterferon beta-1a′ (multiple sclerosis), sarilumab (rheumatoid arthritis), semaglutide (type 2 diabetes, obesity), dupilumab (atopic dermatitis, asthma, nasal polyps, allergies), glucagon (acute hypoglycaemia), epinephrine (anaphylaxis), insulin (diabetes), atropine and vedolizumab (inflammatory bowel diseases (e.g. Crohn's disease and ulcerative colitis)). Pharmaceutical formulations including, but not limited to, any drug described herein are also contemplated for use in the medicament delivery devices described herein, for example pharmaceutical formulations comprising a drug as listed herein (or a pharmaceutically acceptable salt of the drug) and a pharmaceutically acceptable carrier. Pharmaceutical formulations comprising a drug as listed herein (or a pharmaceutically acceptable salt of the drug) may include one or more other active ingredients, or may be the only active ingredient present.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Some aspects of the invention are outlined in the following clauses.

1. A method of a receiver (11) of associating a designated user with a medicament delivery device configured to communicate a medicament delivery event wirelessly to the receiver (11), comprising:
receiving (S101) a wireless signal identifying a medicament delivery device (10, 12) communicating a medicament delivery event;
determining (S102) whether or not timing of receiving the signal complies with an expected medicament delivery schedule of the designated user; and if so:
determining (S103) that the identified medicament delivery device (10) was used by the designated user for causing the medicament delivery event.
   2. The method of clause 1, the determining (S103) that the identified medicament delivery device was used by the designated user for causing the medicament delivery event further comprising:
registering the communicated medicament delivery event with the designated user.
   3. The method of clauses 1 or 2, further comprising:
determining (S102a) whether or not strength of the received wireless signal complies with an expected signal strength; and if so determining that the identified medicament delivery device (10) was used by said user for causing the medicament delivery event.
   4. The method of clause 3, the strength of the received wireless signal complying with an expected signal strength if the signal strength exceeds a predetermined signal strength threshold value.
   5. The method of clauses 3 or 4, further comprising:
acquiring (S102b) information indicating the signal strength of the identified medicament delivery device (10) as measured by at least one neighbouring receiver (13); and
determining (S102c) whether or not the signal strength of the identified medicament delivery device (10) is greater at the receiver (11) than the at least one neighbouring receiver (13); and if so determining that the identified medicament delivery device (10) was used by said user for causing the medicament delivery event.
   6. The method of clause 5, the acquiring (S102b) of information indicating the signal strength comprising:
acquiring information indicating the signal strength of the identified medicament delivery device (10) as measured by at least two neighbouring receivers (13, 14); and the determining (S102c) whether or not the signal strength of the identified medicament delivery device (10) is greater at the receiver (11) than the at least one neighbouring receiver (13) comprises:
triangulating a position of the identified medicament delivery device (10) based on the signal strengths, wherein if the identified medicament delivery device (10) is closer to the receiver (11) than the at least two neighbouring receivers (13, 14), determining that the identified medicament delivery device (10) was used by said user for causing the medicament delivery event.
   7. A method of a receiver (11) of associating a designated user with a medicament delivery device configured to communicate a medicament delivery event wirelessly to the receiver (11), comprising:
receiving (S201) at least two wireless signals each identifying a medicament delivery device (10, 12), at least one of the signals communicating an occurring medicament delivery event;
determining whether or not a plurality of the received at least two signals identifies the same medicament delivery device (10); and if so
determining (S103) that the identified medicament delivery device (10) identified by a plurality of signals was used by the designated user for causing the medicament delivery event.
   8. A computer program (112) comprising computer-executable instructions for causing a receiver (11) to perform steps recited in any one of clauses 1-7 when the computer-executable instructions are executed on a processing unit (111) included in the receiver (11).
   9. A computer program product comprising a computer readable medium (113), the computer readable medium having the computer program (112) according to clause 8 embodied thereon.
   10. A receiver (11) configured to associate a designated user with a medicament delivery device configured to communicate a medicament delivery event wirelessly to the receiver (11), the receiver (11) comprising a processing unit (111) and a memory (113), said memory containing instructions (112) executable by said processing unit (111), whereby the receiver (11) is operative to:
receive a wireless signal identifying a medicament delivery device (10, 12) communicating a medicament delivery event;
determine whether or not timing of receiving the signal complies with an expected medicament delivery schedule of the designated user; and if so to:
determine that the identified medicament delivery device (10) was used by the designated user for causing the medicament delivery event.
   11. The receiver (11) of clause 10, further being operative to, when determining that the identified medicament delivery device was used by the designated user for causing the medicament delivery event:
register the communicated medicament delivery event with the designated user.
   12. The receiver (11) of clauses 10 or 11, further being operative to:
determine whether or not strength of the received wireless signal complies with an expected signal strength; and if so determining that the identified medicament delivery device (10) was used by said user for causing the medicament delivery event.
   13. The receiver (11) of clause 12, further being operative to determine that the strength of the received wireless signal complies with an expected signal strength if the signal strength exceeds a predetermined signal strength threshold value.
   14. The receiver (11) of clauses 12 or 13, further being operative to:
acquire information indicating the signal strength of the identified medicament delivery device (10) as measured by at least one neighbouring receiver (13); and
determine whether or not the signal strength of the identified medicament delivery device (10) is greater at the receiver (11) than the at least one neighbouring receiver (13); and if so to determine that the identified medicament delivery device (10) was used by said user for causing the medicament delivery event.
   15. The receiver (11) of clause 14, further being operative to, when acquiring information indicating the signal strength:
acquire information indicating the signal strength of the identified medicament delivery device (10) as measured by at least two neighbouring receivers (13, 14); and to, when determining whether or not the signal strength of the identified medicament delivery device (10) is greater at the receiver (11) than the at least one neighbouring receiver (13):
triangulate a position of the identified medicament delivery device (10) based on the signal strengths, and if the identified medicament delivery device (10) is closer to the receiver (11) than the at least two neighbouring receivers (13, 14), to determine that the identified medicament delivery device (10) was used by said user for causing the medicament delivery event.
   16. A receiver (11) configured to associate a designated user with a medicament delivery device configured to communicate a medicament delivery event wirelessly to the receiver (11), the receiver (11) comprising a processing unit (111) and a memory (113), said memory containing instructions (112) executable by said processing unit (111), whereby the receiver (11) is operative to:
receive at least two wireless signals each identifying a medicament delivery device (10, 12), at least one of the signals communicating an occurring medicament delivery event;
determine whether or not a plurality of the received at least two signals identifies the same medicament delivery device (10); and if so to
determine that the identified medicament delivery device (10) identified by a plurality of signals was used by the designated user for causing the medicament delivery event.

1-15. (canceled)

16. A method of a receiver of associating a designated user with a medicament delivery device configured to communicate a medicament delivery event wirelessly to the receiver, comprising:
receiving a wireless signal identifying a medicament delivery device communicating a medicament delivery event;
determining whether or not timing of receiving the signal complies with an expected medicament delivery schedule of the designated user; and if so:
determining that the identified medicament delivery device was used by the designated user for causing the medicament delivery event.

17. The method of claim 16, the determining that the identified medicament delivery device was used by the designated user for causing the medicament delivery event further comprising:
registering the communicated medicament delivery event with the designated user.

18. The method of claim 16, further comprising:
determining whether or not strength of the received wireless signal complies with an expected signal strength; and if so determining that the identified medicament delivery device was used by said user for causing the medicament delivery event.

19. The method of claim 18, the strength of the received wireless signal complying with an expected signal strength if the signal strength exceeds a predetermined signal strength threshold value.

20. The method of claim 18, further comprising:
acquiring information indicating the signal strength of the identified medicament delivery device as measured by at least one neighbouring receiver; and
determining whether or not the signal strength of the identified medicament delivery device is greater at the receiver than the at least one neighbouring receiver; and if so determining that the identified medicament delivery device was used by said user for causing the medicament delivery event.

21. The method of claim 20, the acquiring of information indicating the signal strength comprising:
acquiring information indicating the signal strength of the identified medicament delivery device as measured by at least two neighbouring receivers; and the determining whether or not the signal strength of the identified medicament delivery device is greater at the receiver than the at least one neighbouring receiver comprises:
triangulating a position of the identified medicament delivery device based on the signal strengths, wherein if the identified medicament delivery device is closer to the receiver than the at least two neighbouring receivers, determining that the identified medicament delivery device was used by said user for causing the medicament delivery event.

22. A method of a receiver of associating a designated user with a medicament delivery device configured to communicate a medicament delivery event wirelessly to the receiver, comprising:
receiving at least two wireless signals each identifying a medicament delivery device, at least one of the signals communicating an occurring medicament delivery event;
determining whether or not a plurality of the received at least two signals identifies the same medicament delivery device; and if so
determining that the identified medicament delivery device identified by a plurality of signals was used by the designated user for causing the medicament delivery event.

23. A computer program comprising computer-executable instructions for causing a receiver to perform steps recited in claim 16 when the computer-executable instructions are executed on a processing unit included in the receiver.

24. A computer program product comprising a computer readable medium, the computer readable medium having the computer program according to claim 23 embodied thereon.

25. A receiver configured to associate a designated user with a medicament delivery device configured to communicate a medicament delivery event wirelessly to the receiver, the receiver comprising a processing unit and a memory, said memory containing instructions executable by said processing unit, whereby the receiver is operative to:
receive a wireless signal identifying a medicament delivery device communicating a medicament delivery event;
determine whether or not timing of receiving the signal complies with an expected medicament delivery schedule of the designated user; and if so to:
determine that the identified medicament delivery device was used by the designated user for causing the medicament delivery event.

26. The receiver of claim 25, further being operative to, when determining that the identified medicament delivery device was used by the designated user for causing the medicament delivery event:
register the communicated medicament delivery event with the designated user.

27. The receiver of claim 25, further being operative to:
determine whether or not strength of the received wireless signal complies with an expected signal strength; and if so determining that the identified medicament delivery device was used by said user for causing the medicament delivery event.

28. The receiver of claim 27, further being operative to determine that the strength of the received wireless signal complies with an expected signal strength if the signal strength exceeds a predetermined signal strength threshold value.

29. The receiver of claim 27, further being operative to:
acquire information indicating the signal strength of the identified medicament delivery device as measured by at least one neighbouring receiver; and
determine whether or not the signal strength of the identified medicament delivery device is greater at the receiver than the at least one neighbouring receiver; and if so to determine that the identified medicament delivery device was used by said user for causing the medicament delivery event.

30. A receiver configured to associate a designated user with a medicament delivery device configured to communicate a medicament delivery event wirelessly to the receiver, the receiver comprising a processing unit and a memory, said memory containing instructions executable by said processing unit, whereby the receiver is operative to:
receive at least two wireless signals each identifying a medicament delivery device, at least one of the signals communicating an occurring medicament delivery event;
determine whether or not a plurality of the received at least two signals identifies the same medicament delivery device; and if so to
determine that the identified medicament delivery device identified by a plurality of signals was used by the designated user for causing the medicament delivery event.
